(19) United States
(12) Patent Application Publication
(10) Pub. No.: US 2013/0271015 A1
(43) Pub. Date: Oct. 17, 2013

(54) LIGHTING SYTEM AND METHOD THEREOF

(71) Applicants: Sheng Peng, Shanghai (CN); Di Lou, Shanghai (CN)

(72) Inventors: Sheng Peng, Shanghai (CN); Di Lou, Shanghai (CN)

(73) Assignee: KONINKLIJKE PHILIPS N.V., EINDHOVEN (NL)

(21) Appl. No.: 13/976,748

(22) PCT Filed: Dec. 23, 2011
(86) PCT No.: PCT/IB2011/055929

§ 371 Date: Jun. 27, 2013

(30) Foreign Application Priority Data
Dec. 31, 2010 (CN) PCT/CN2010/002235

(51) Int. Cl. H05B 37/02

(52) U.S. Cl. CPC H05B 37/02
USPC 315/158

(57) ABSTRACT

Nightlight with motiondetector The present invention discloses a lighting system comprising: a light source, configured to generate light having wavelength in the range of [550 nm, 700 nm]; a sensor, configured to detect an activity of an object; and a controller, configured to control the working status of the light source based on the detection result of the sensor. The present invention further discloses a method of providing light.

### TECHNICAL FIELD

The invention relates to a lighting system, especially a lighting system and method for use at night.

### BACKGROUND OF THE INVENTION

It has long been known that nocturnal biological activities such as urination disrupt the continuity of sleep quality. People who wake up to urinate often have the experience of blundering about the room and feeling for the light switch, and finally when the light is turned on, the person is almost fully awake.

Melatonin is a hormone which shows a daily cycle and which is considered to be a marker of the phase of the biological rhythms. Melatonin is generally known as a sleeping hormone that influences the alertness of the human being. A relatively low melatonin level stimulates alertness, while a relatively high melatonin level increases sleepiness.

It has also been found that walking and staying under conventional lighting conditions for about one minute is long enough to change the melatonin level, so that some people may find it more difficult to fall back to sleep than others. Some hotels have installed a separate night light luminaire, and some homes use decorating night light with dim light. However, the wavelength is not specifically selected to maintain the melatonin level constant for better sleep quality.

Nocturia is defined as the need to get up to urinate two or more times per night for three or more days per week. In a recent study on self-reported nocturia among community-dwelling older adults, 55% of the participants endorsed nocturia, and 23% endorsed nocturia and difficulty going back to sleep. Participants who endorsed nocturia and difficulty going back to sleep were more likely to report poor sleep quality, daytime sleepiness, increased disease burden, one or more falls, and symptoms related to primary sleep disorders. For a person not suffering from nocturia who wakes up only once per night, the sleep quality may also be disrupted and he may have difficulty going back to sleep.

So, there is a need to have a lighting system that can provide a proper lighting condition that is safe enough for nocturnal biological activities but that also can maintain melatonin at a constant level for better sleep quality, so that the person affected, especially the person who endorses nocturia, can get a better sleep quality.

### SUMMARY OF THE INVENTION

It is an object of the invention to solve or at least mitigate at least one of the above discussed problems.

According to one embodiment, there is provided a lighting system comprising: a light source, configured to generate light having a wavelength in the range of [550 nm, 700 nm]; a sensor, configured to detect an activity of an object; and a controller, configured to control the working status of the light source, based on the detection result of the sensor. In one embodiment, the working status of the light source can be as simple as turned on or turned off. However, in some other embodiments, the working status of the light source can mean that the light source provides light having different light intensities in different working statuses.

Since longer wavelength light is too weak, although not entirely inactive, to regulate the melatonin level, and the lighting system of the embodiment can emit light of a longer wavelength in the range of [550 nm, 700 nm], the melatonin level will not be suppressed too much under the lighting conditions provided by the lighting system of the embodiment, and the sleep quality of people affected by nocturnal biological activities will not be influenced too much.

It has been found that red light does not help people see better in the dark, and people at home or staying at a hotel prefer warm yellow light at night rather than green or red light. Taking this into consideration, optionally, the light emitted by the lighting system of the embodiment can have a wavelength in the range of [600 nm, 625 nm].

The lighting system of the embodiment can turn on the light source when relevant activity by a person is detected and turn off the light source when no activity is detected, so that the necessity of feeling for the light switch by said person is removed and the possibility of the sleep hormone being disturbed is further reduced.

Optionally, in the lighting system of the embodiment, the sensor is further configured to detect the activity level of the object, and the controller is further configured to control the light source to generate light having a different light intensity corresponding to the detected different activity level of the object. In general, an elderly person may require a higher intensity of light to see safely than younger persons, so that by setting the light intensity based on the detected activity level and taking into account the age of the person involved, the light intensity can be set for various persons to a more proper value that is safe enough for walking around at night but not so high that it disturbs people's melatonin level, so that the lighting system can be more suitable for persons of different ages.

According to another embodiment, there is provided a method of providing light, the method comprising the steps of:
i). detecting an activity of an object by a sensor; and
ii). controlling the working status of a light source, based on the detection result of the sensor, wherein the light generated by the light source in a working status has a wavelength in the range of [550 nm, 700 nm].

Optionally, the lighting method of the invention further comprises the steps of: detecting the level of the activity of the object; and controlling the light source to generate light having a different light intensity corresponding to the detected different activity level of the object.

Additionally, a set of computer executable instructions is provided to perform any one of the steps of the methods according to the present invention.

### BRIEF DESCRIPTION OF THE DRAWINGS

The objects, advantages and effects as well as features of the invention will be more readily understood from the following detailed description of exemplary embodiments of the invention when read together with the accompanying drawings, in which:

FIG. 1 shows schematically a block diagram of a lighting system according to an embodiment of the invention;

FIG. 2 shows a detail structure of the light source of the lighting system according to an embodiment of the invention;

FIG. 3 shows a detail structure of the light source of the lighting system according to another embodiment of the invention; and

FIG. 4 illuminates schematically a flowchart of a lighting method according to an embodiment of the invention.

### DETAILED DESCRIPTION OF THE EMBODIMENTS

While the invention covers various modifications and alternative constructions, embodiments of the invention are shown in the drawings and will hereinafter be described in detail. However, it is to be understood that the specific description and drawings are not intended to limit the invention to the specific forms disclosed. On the contrary, the scope of the claimed invention is intended to include all modifications and alternative constructions thereof falling within the scope of the invention as expressed in the appended claims.

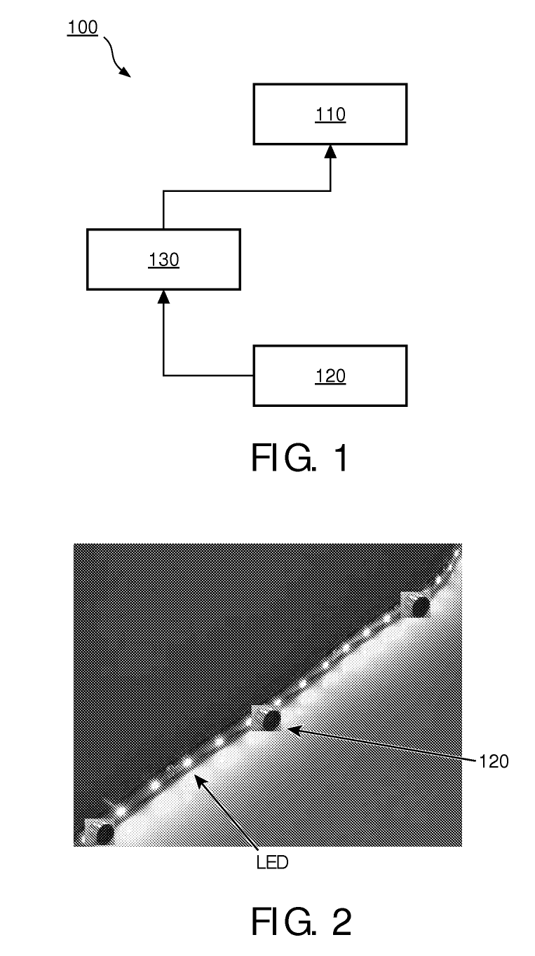

FIG. 1 shows schematically a block diagram of a lighting system 100 according to an embodiment of the invention. Lighting system 100 comprises a light source 110, a sensor 120 and a controller 130.

Light source 110 can be a single lamp, a plurality of lamps, a light strip, a light guide plate or light guide bar incorporating lamp, or any combination of these lamps or other applicable lamps or luminaires. Light source 110 can emit light with a wavelength in the range of [550 nm, 700 nm]. It is known that short wavelength light tends to be more effective for melatonin suppression than long wavelength light, and hence is more likely to disturb sleep quality. It has been found that blue light is far more effective to suppress melatonin than green light. Light with a longer wavelength is too weak, although not entirely inactive, to regulate the melatonin level. For these reasons, the wavelength of the light illuminated by the light source 110 is selected in the range of [550 nm, 700 nm], which can minimize sleep quality disturbance.

In addition, because red light does not help people see better in the dark, and people at home or staying at a hotel prefer warm yellow light at night rather than green or red light, optionally, according to an embodiment of the invention, the light source 110 can emit light with a wavelength in the range of [600 nm, 625 nm] which may be more suitable for people at home or staying at a hotel.

The sensor 120 can detect an activity of an object, such as people who need the light of the lighting system 100. In an embodiment of the invention, the sensor 120 can be an acoustic sensor for detecting the activity of the object or the presence of the object. It should be noted that the sensor 120 is not limited to an acoustic sensor, i.e. any other sensor, such as an ultrasonic sensor, IR sensor, coded light sensor, imaging camera, or any combination thereof which can detect the activity or presence of the object can also be used within the protective scope of the invention. The word “activity” not only covers “movement” of the object, but also covers “presence” of the object.

According to an embodiment of the invention, the activity of the object being detected may comprise the pace frequency of people. It should be noted that the activity is not limited to the pace frequency, i.e. any other activities which can reflect the nature of people to some degree can also be detected by the sensor within the protective scope of the invention.

The controller 130 can control the light source 110 to work in different working statuses, based on the activity detected by the sensor 120. The working status can be power on or power off, but can also consist in generating light having different light intensities. As an example, the controller 130 turns on at least a part of the light source 110 upon detecting activity of the object and turns off the at least one part of the light source 110 when no activity of the person is detected. The part of the light source 110 near the person is turned on by the controller to provide illumination to the person present near the light source and is turned off when said person is no longer near the light source 110, so that a sleep disturbing activity such as turning on or off the light source 110 is not necessary and the possible disturbance of the sleep hormone is further reduced.

Optionally, the light intensity of the light illuminated by the light source 100 is specially selected. The light intensity is selected based on the following criteria: light level of the lighting system should be safe enough for people to walk around at night but not so high that it disturbs people's melatonin level. According to an embodiment of the invention, the average illuminance provided by the lighting system 100 at a target area, for example the floor or the wall where the light source is installed, is about 40 lux, providing a sufficient light level for safe walking, but not so high as to make it difficult for a person to resume his sleep afterwards.

According to an embodiment of the invention, the sensor 120 can detect the activity level of an object, and the controller 130 can set an intensity level of the light emitted by the light source 110 based on the detected level of the activity. In general, an elderly person may require a higher intensity of light to see safely than younger persons; therefore, in order to provide a proper light intensity taking into consideration the age of a person, the activity level of a person which may reflect the age of this person to some degree can be used by the controller 130 to control the light intensity of the light from the light source 110, so that the light level of the lighting system can be suitable for all kinds of people.

Optionally, the lighting system 100 can further comprise an interface, which is configured to receive a signal which may be input from a user and which represents a preference of the user. The controller 130 can store the signal and control the light source 110 to generate different light, based not only on the detection result of the sensor 120, but also taking the signal into account. By virtue thereof, the advantage of personalized configuration is provided.

Optionally, the controller 130 can set the light intensity of the light from the light source 110 as one of two light intensities: a first, high intensity which may be suitable for elderly persons and a second, low intensity which may be suitable for younger persons. When the detected activity level is high, which implies at least to some degree that the people involved may belong to a younger age group, the controller 130 can set the light intensity to the second intensity, whereas if the detected activity level is low, which may imply that the people may belong to an older age group, the controller 130 can set the light intensity to the first intensity. It should be understood that the higher activity level and the lower activity level can also relate to activities other than age of people. For example, a higher activity level may relate to people walking fast, which need a higher illumination level to provide wider coverage and better illumination; a lower activity level may relate to slow walking people, in which situation a narrower coverage and a lower illumination level is enough.

There may be several ways to determine whether the detected activity level is high or low. For example, there may exist a predetermined threshold value based on for example previous experiments or the knowledge of those skilled in the art; and the activity level higher than the threshold value can be attributed to a high activity level, and vice versa.

According to an embodiment of the present invention, when the lighting system is applicable in a place where only a limited number of people would use the lighting system, such as in a home situation with a predetermined number of people, the light intensity of the light from the light source 110 can be preset for people using the lighting system 100. That is to say, the sensor 120 can detect the activity level of the people and the controller 130 can associate the detected activity level of the people with the light intensity set in advance by the people. When the lighting system 100 is in operation, the controller 130 can set the light intensity of the light source 110 to the preset light intensity associated with the detected activity level.

In the lighting system 100, the wavelength of LED light emitted is selected to be around 625 nm to provide minimum melatonin suppression, so that the melatonin level of people walking in the LED light can be well maintained, and they have no problem going back to sleep. In addition, the lighting system 100 also includes a controller 130 to turn on the light source 110 when needed, so that a sleep disturbing human activity such as turning on the light switch is not necessary.

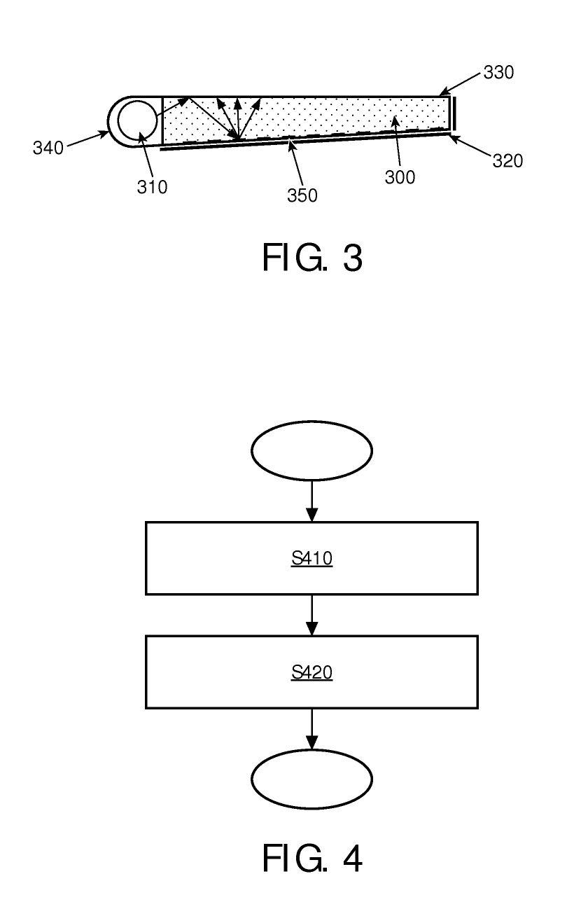

The lighting system 100 can be used in various applications where various types of light sources are required due to the space limitation of the application. FIGS. 2 and 3 show various types of light source 110 which can be used in the lighting system 100.

FIG. 2 shows a detail structure of the light source 110 of the lighting system 100 according to an embodiment of the invention. The light source 110 is a light line comprising a plurality of spaced apart LEDs arranged in the line direction. The light coming from the LED light line can be diffused, so that the lighting system can provide a uniform light output. When the LED light line is used in practice, it may be provided on the lower end of the wall and it extends from the bedroom to the bathroom so as to provide a suitable light condition for people during nocturnal biological activities. Optionally, since the LED light line extends from the bedroom to the bathroom, the controller 130 can turn on the part of the light line which is proximate to the person present when the activity of this person has been detected. As is also shown in FIG. 2, the sensor 120 can comprise a plurality of sensor units which can also be arranged together with the LEDs.

FIG. 3 shows a detail structure of another type of light source 110 of the lighting system 100 according to another embodiment of the invention. The light source 110 comprises at least one light guide bar arranged according to the requirements in terms of space of the practical application, said at least one bar of the light source 110 being a light guide 300. The light guide 300 comprises an LED 310 at one end of the light guide to input light into the light guide 300. One side 320 of the light guide 300 that extends parallel to the linear direction of the light guide 300 (this side 320 may extend along the wall in practice) is coated with highly reflective material, so that light emitted by the LED 310 exits from the opposite side 330 of the light guide 300 and illuminates the floor on which people walk at night. The light guide 300 further comprises a reflector 340 arranged around the LED 310 for reflecting the light incident on the reflector into the light guide.

As there is a loss of light transmitted in the linear direction of the light guide, the density of the coated material is not uniformly distributed to provide a uniform illumination output. Generally, the density of the coated reflective material on a part of the side 320 near the LED is smaller than on a part remote from the LED 330. According to the light source of FIG. 3, the number of required LEDs has been greatly reduced, so that the cost of such apparatus can be lower than that of the structure shown in FIG. 2.

Optionally, a panel technology is used in the second embodiment, enabling light coming out of the light guide to be diffused more uniformly, resulting in a reduction of sleep hormone disturbance.

FIG. 4 shows a flow chart of a lighting method 400 according to an embodiment of the invention. The lighting method 400 can be performed by the lighting system 100 of the invention. The lighting method 400 begins with step S410, in which detection of an activity of an object by a sensor takes place. The sensor can be the sensor 120 of the lighting system as described above, or can be any one or more sensors selected from the group comprising an acoustic sensor, an ultrasonic sensor, an IR sensor, a coded light sensor, an imaging camera, or any combination thereof, which can detect the activity or the presence of the object. The object can be people who need the light produced by means of the lighting method, such as people involved in a nocturnal biological activity and needing a night lighting condition. As described above, the activity of the object being detected may comprise people's pace frequency. It should be noted that the activity is not limited to pace frequency; any other activities which can reflect the nature of people to some degree can also be detected by the sensor within the protective scope of the invention.

Then, the method proceeds to step S420 of controlling the working status of a light source based on the detection result of the sensor, wherein the light generated by the light source in a working status has a wavelength in the range of [550 nm, 700 nm]. In detail, when the activity of an object has been detected, at least one part of the light source is turned on, and when no activity has been detected, the at least one part of the light source is turned off. It should be noted that step S420 may be performed by the controller of the lighting system.

As described above, light with a long wavelength is too weak, although not entirely inactive, to regulate the melatonin level; the light emitted by the light source after it has been turned on should have a long wavelength in the range between 550 nm and 700 nm. In addition, taking into consideration that the people in question should feel comfortable, the wavelength can be selected to be in a range between 600 nm and 625 nm.

As described above, the light intensity of the light produced by means of the lighting method should be specially selected, so that the average illuminance provided by means of the lighting method is about 40 lux, being a sufficient light level for safe walking, but not so high as to make it difficult for people to go back to sleep.

According to an embodiment of the invention, in step S410, the sensor further detects the activity level of the object, and the lighting method further comprises a step of setting the intensity of the light emitted by the light source, based on the detected activity level. As described above, people of different age groups may require light with a different light intensity, which can be achieved by setting the light intensity according to the detected activity level which may reflect the age of people at least to some degree. The light level produced by means of the lighting method can be suitable for all kinds of people.

Optionally, when the lighting method is performed in a place where only a limited number of people would need the light condition produced by means of the lighting method, such as in a home situation with a predetermined number of people, the method can further comprise a step of presetting the light intensity of the light for those people. That is, the activity level of the people can be detected by the sensor and the detected activity level of the people can be associated with the light intensity set by the people in advance. Then, when activity has been detected in step S410, the light intensity of the light source is set to the preset light intensity associated with the detected activity level.

Optionally, when setting an intensity level of the light in the lighting method, the light intensity of the light from the light source can be set to one of two light intensities: a first, high intensity which may be suitable for elderly people and a second, low intensity which may be suitable for younger people. When the detected activity level is high, which at least to some degree implies the people may be younger, the light intensity is set to the second intensity, whereas if the detected activity level is low, which may imply the people are older, then the light intensity is set to the first intensity.

The invention further provides a set of computer executable instructions configured to perform the above steps. While the invention has been discussed in the context of computer executable instructions, it should be understood that the instructions may be implemented in hardware circuitry, computer program code, or any combination of hardware circuitry and computer program code.

It should be noted that the aforesaid embodiments should be interpreted as illustrative of this invention and not in a limiting sense; substitute embodiments may be designed by those skilled in the art without departing from the scope of the appended claims. The word “include” does not exclude elements or steps other than those listed in the claims. The word “a” or “an” preceding the elements does not exclude the presence of a plurality of such elements. This invention can be implemented by means of hardware including several different elements or by means of a suitably programmed computer. In the unit claims that list several means, several of these means can be specifically embodied in the same hardware item. The use of words such as first, second, third does not represent any order, but instead they can be understood as names.

1. A lighting system for getting a better sleep quality comprising:
a light source configured to generate light having a wavelength in the range from 550 nm to 700 nm;
a sensor configured to detect an activity of an object; and
a controller configured to control the working status of the light source, based on the detection result of the sensor.

2. The lighting system of claim 1, wherein the light source is further configured to generate light having a wavelength in the range of [600 nm, 625 nm].

3. The lighting system of claim 1, wherein the sensor is further configured to detect the activity level of the object, and the controller is further configured to control the light source to generate light having a different light intensity corresponding to the detected different activity level of the object.

4. The lighting system of claim 1, wherein the light generated by the light source has an average illuminance of at least 40 lux at a target area.

5. The lighting system of claim 1, further comprising:
an interface, configured to receive a signal representing a preference of the object; wherein the cont oiler is further configured to store the signal and control the light source taking said signal into consideration.

6. The lighting system of claim 3, wherein the light source is capable of generating light having any one of a first light intensity and a second light intensity, the second light intensity being lower than the first light intensity, and the controller is further configured to control the light source to generate light having the first intensity when the detected activity level is high, and to control the light source to generate light having the second intensity when the detected activity level is lower.

7. The lighting system of any one of claims 1, wherein the sensor selected from the group of sensors comprises an acoustic sensor, an IR sensor, an ultrasonic sensor and an imaging camera sensor.

8. The lighting system of any one of claims 1, wherein the activity of the object comprises the pace frequency of the object.

9. A method of providing light for getting a better sleep quality, comprising the steps of:
i). detecting an activity of an object by a sensor; and
ii). controlling the working status of a light source, based on the detection result of the sensor, wherein the light generated by the light source in the working status has a wavelength in the range from 550 nm to 700 nm.

10. The method of claim 9, wherein the light has a wavelength in the range of [600 nm, 625nm].

11. The method of claim 9, wherein detecting further comprises a step of:
detecting the activity level of the object;
and controlling further comprises a step of:
controlling the light source to generate light having a different light intensity corresponding to the detected different activity level of the object.

12. The method of claim 9, wherein the light generated by the light source has an average illuminance of at least 40 lux at a target area.

13. The method of claim 11, wherein the light source is capable of generating light having any one of a first light intensity and a second light intensity, the second light intensity being lower than the first light intensity, and the controller is further configured to control the light source to generate light having the first intensity when the detected activity level is high, and to control the light source to generate light having the second intensity when the detected activity level is lower.

14. A non-transitory computer readable medium embodying comprising computer instructions which, when executed by a processor, configure the processor to perform the steps of:
detecting an activity of an object by a sensor; and
controlling the working status of a light source, based on the detection result of the sensor, wherein the light generated by the light source in the working status has a wavelength in the range from 550 nm to 700 nm.

15. The non-transitory computer readable medium of claim 14, wherein the light has a wavelength in the range from 600 nm to 625 nm.

16. The non-transitory computer readable medium of claim 14, wherein detecting further comprises a step of:
detecting the activity level of the object;
and controlling further comprises a step of:
controlling the light source to generate light having a different light intensity corresponding to the detected different activity level of the object.

17. The non-transitory computer readable medium of claim 14, wherein the light generated by the light source has an average illuminance of at least 40 lux at a target area.

18. The non-transitory computer readable medium of claim 17, wherein the light source is capable of generating light having any one of a first light intensity and a second light intensity, the second light intensity being lower than the first light intensity, and the controller is further configured to control the light source to generate light having the first intensity when the detected activity level is high, and to control the light source to generate light having the second intensity when the detected activity level is lower.
